(19) United States
(12) Patent Application Publication
(10) Pub. No.: US 2021/0065939 A1
(43) Pub. Date: Mar. 4, 2021

(54) DUAL-PORT ELECTRONIC ASSEMBLY

(71) Applicant: PEGATRON CORPORATION, Taipei (TW)

(72) Inventor: Jian-En Li, Taipei (TW)

(21) Appl. No.: 16/899,726

(22) Filed: Jun. 12, 2020

(30) Foreign Application Priority Data
Aug. 26, 2019 (TW) 108130506

(51) Int. Cl. H01C 1/02; H01C 7/02; H01C 7/04

(52) U.S. Cl. CPC H01C 1/02; H01C 7/04; H01C 7/02

(57) ABSTRACT

A dual-port electronic assembly includes a housing and two electronic components. The housing includes a body, two positioning parts and a spacer. The body includes an accommodating space, an opening and two slots. The opening is located at a side of the accommodating space. The two slots are respectively located at two opposite sides of the opening. The two positioning parts are arranged in the accommodating space, and the two positioning parts are respectively located on two sides different from the two sides the slots are arranged at. The spacer is arranged in the accommodating space and located between the two positioning parts. A positioning groove is formed between each positioning part and the spacer. Each electronic component includes a main body and two pins. The main body is located in the positioning groove. The two pins are respectively arranged

### CROSS-REFERENCE TO RELATED APPLICATION

This application claims the priority benefit of Taiwan application serial no. 108130506, filed on Aug. 26, 2019. The entirety of the above-mentioned patent application is hereby incorporated by reference herein and made a part of this specification.

### BACKGROUND

### Technical Field

The present disclosure is directed to a dual-port electronic assembly, in particular to a dual-port electronic assembly capable of fixing two electronic components and reducing the influence of parasitic capacitance.

### Related Art

In the manufacturing process of electronic components, sometimes a plurality of electronic components is firstly packaged and then assembled. In this way, the relative position of each electronic component can be limited by using a packaging structure. Further, the packaging structure can also make subsequent connections between circuit boards or other electronic components more convenient.

For example, common thermistors include Positive Temperature Coefficient (PTC) thermistors and Negative Temperature Coefficient (NTC) thermistors. The two types of thermistors are semi-conducting ceramic devices, which can be used in circuits to avoid overcurrent of sensitive parts. Nowadays, in order to meet all kinds of demands, two thermistors are combined into Surface Mounted Device (SMD) thermistors for use, or two thermistors are directly assembled for use.

### SUMMARY

In order to solve the above problem, in one embodiment, the present disclosure provides a dual-port electronic assembly including a housing and two electronic components. The housing includes a body, two positioning parts and a spacer. The body includes an accommodating space, an opening and two slots. The opening is located in one side of the accommodating space. The two slots are respectively located at two opposite sides of the opening. The two positioning parts are arranged in the accommodating space, and the two positioning parts are respectively located on two sides different from the two sides the slots are arranged at. The spacer is arranged in the accommodating space and located between the two positioning parts such that a positioning groove is formed between each positioning part and the spacer. Each electronic component includes a main body and two pins. The main body of each electronic component is located in the positioning groove. The two pins of each electronic component are respectively arranged in the two slots.

Therefore, when the two electronic components need to be assembled into the housing, the two electronic components only need to be placed into the accommodating space of the housing. At this moment, under the limit of the positioning parts and the spacer, the electronic components can be arranged in the positioning groove in a sliding manner to complete positioning and assembling. At the same time, the pins of the electronic components are arranged in the two slots in the two sides. In this way, under the effect of the positioning parts and the spacer, the electronic components can be fixed at a specific position without rotating or displacing, and can also be quickly arranged at a required position during assembling, thus improving the assembling speed. Moreover, through the slots, the pins can be positioned at a specific position, and the flatness of the assembled pins can also be improved, such that SMT operation can be smoother and the waste of solder paste can be reduced. In addition, the influence of parasitic capacitance between the two electronic components can also be reduced by arranging the spacer.

Detailed features and advantages of the present disclosure are described in detail in the following implementations, and the content of the implementations is sufficient for a person skilled in the art to understand and implement the technical content of the present disclosure. A person skilled in the art can easily understand the objectives and advantages related to the present disclosure according to the contents disclosed in this specification, the claims and the drawings.

### BRIEF DESCRIPTION OF THE DRAWINGS

FIG. 1 is a three-dimensional view of a dual-port electronic assembly according to one embodiment of the present disclosure.

FIG. 2 is an exploded view of a dual-port electronic assembly according to one embodiment of the present disclosure.

FIG. 3 is a cross-sectional view of a dual-port electronic assembly according to one embodiment of the present disclosure.

### DETAILED DESCRIPTION

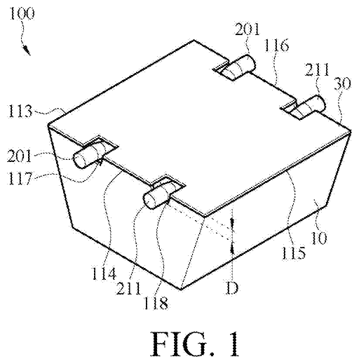

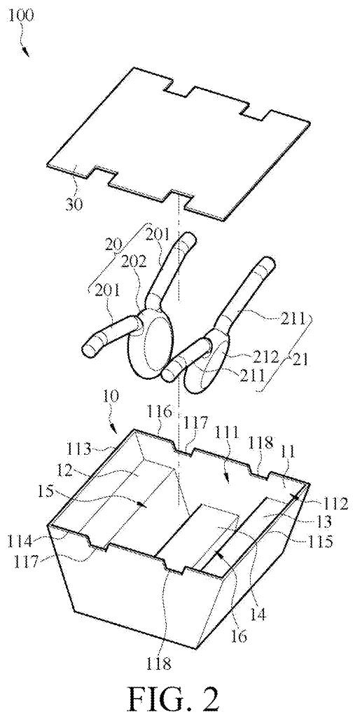

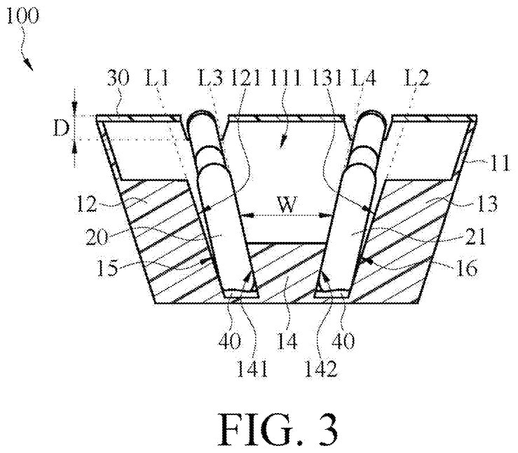

Referring to FIG. 1 to FIG. 3, FIG. 1 is a three-dimensional view of a dual-port electronic assembly according to one embodiment of the present disclosure. FIG. 2 is an exploded view of a dual-port electronic assembly according to one embodiment of the present disclosure. FIG. 3 is a cross-sectional view of a dual-port electronic assembly according to one embodiment of the present disclosure. A dual-port electronic assembly 100 according to this embodiment may be arranged upside down on a circuit board, as illustrated in FIG. 1. The dual-port electronic assembly 100 illustrated in FIG. 1 is used to illustrate assembling and an internal structure. Therefore, the dual-port electronic assembly 100 is upside down such that pins 201, 211 face upwards. In fact, when applied or assembled, an end with the pins 201, 211 is assembled towards a connecting position on the circuit board according to the position of the circuit board. That is to say, if the circuit board is located below, the dual-port electronic assembly 100 is inverted and arranged on the circuit board such that the pins 201, 211 are connected to a circuit on the circuit board. The dual-port electronic assembly 100 according to this embodiment includes a housing 10 and two electronic components 20, 21.

In some embodiments, the electronic components 20, 21 may be thermistors respectively, but the present disclosure is not limited thereto.

As can be seen from FIG. 1 and FIG. 2, the housing 10 includes a body 11, two positioning parts 12, 13 and a spacer 14. The body 11 is provided with an accommodating space 111, an opening 112 and two slots 117, 118. The opening 112 is located at a side of the accommodating space 111. As can be seen from FIG. 2, the body 11 is surrounded by a first side 113, a second side 114, a third side 115 and a fourth side 116 to form the opening 112.

Further, the two slots 117, 118 are respectively located at the two opposite sides of the opening 112. In this embodiment, as can be seen from FIG. 2, the two slots 117, 118 are respectively arranged at the second side 114 and the fourth side 116. The positions of the slot 117 at the second side 114 and the slot 117 at the fourth side 116 correspond to each other. The positions of the slot 118 at the second side 114 and the slot 118 at the fourth side 116 correspond to each other.

The two positioning parts 12, 13 are arranged in the accommodating space 111 at a position away from the opening 112. As can be seen from FIG. 2 and FIG. 3, the body 11 is in a shape with an upward opening 112, and the two positioning parts 12, 13 may be arranged in the accommodating space 111 of the body 11 at a position away from the opening 112 and located at the bottom. At the same time, the two positioning parts 12, 13 are respectively located on two sides different from the two sides the slots 117, 118 are arranged at. In this embodiment, the positioning part 12 is located at the bottom of the first side 113, and the positioning part 13 is located at the bottom of the third side 115.

The spacer 14 is also arranged in the accommodating space 111 at a position away from the opening 112. As can be seen from FIG. 2 and FIG. 3, the spacer 14 is arranged in the accommodating space 111 of the body 11 at a position away from the opening 112 and located at the bottom. The spacer 14 is located between the two positioning parts 12, 13 such that a positioning groove 15 is formed between the positioning part 12 and the spacer 14, and a positioning groove 16 is formed between the positioning part 13 and the spacer 14. That is to say, a positioning groove is formed between each positioning part and the spacer.

The electronic components 20, 21 are arranged in the accommodating space 111, the main body of each electronic component is located in one positioning groove, and the two pins of each electronic component are respectively arranged in the slots in the opposite sides of the housing 10. As can be seen from FIG. 2 and FIG. 3, the electronic component 20 includes a main body 202 and two pins 201. The two pins 201 are connected to the main body 202. The main body 201 of the electronic component 20 is located in the positioning groove 15, and the two pins 201 of the electronic component 20 are respectively arranged in the two slots 117 in the opposite sides of the body 11. As can be seen from FIG. 1 and FIG. 2, the two pins 201 are respectively arranged in the slot 117 at the second side 114 and the slot 117 at the fourth side 116 of the body 11.

As can be seen from FIG. 2 and FIG. 3, the other electronic component 21 includes a main body 212 and two pins 211. The two pins 211 are connected to the main body 212. The main body 212 of the other electronic component 21 is located in the positioning groove 16, and the two pins 211 of the electronic component 21 are respectively arranged in the two slots 118 in the opposite sides of the body 11. Similarly, as can be seen from FIG. 1 and FIG. 2, the two pins 211 are respectively arranged in the slot 118 at the second side 114 and the slot 118 at the fourth side 116 of the body 11.

Therefore, when the two electronic components 20, 21 need to be arranged in the housing 10, the two electronic components 20, 21 only need to be placed into the accommodating space 111 of the housing 10. At this moment, under the limit of the positioning parts 12, 13 and the spacer 14, the electronic components 20, 21 can be arranged in the positioning grooves 15, 16 in a sliding manner to complete positioning and assembling. At the same time, the two pins 201, 211 of the electronic components 20, 21 are arranged in the slots 117, 118 at the two sides. In this way, under the effect of the positioning parts 12, 13 and the spacer 14, the electronic components 20, 21 can be fixed at a specific position without rotating or displacing, and can also be quickly arranged at a required position during assembling, thus improving the assembling speed.

By comparison, an existing method to assemble two thermistors is to use a simple rectangular housing with a spacer in the middle, such that the internal portion of the rectangular housing is divided into two sub-slots, then two thermistors are respectively arranged in the two sub-slots, and finally a cover plate is closed. This way often causes high defect rate because of problems such as poor pin flatness, and poor product suction surface flatness. However, through the slots 117, 118 in the present disclosure, the pins 201, 211 can be positioned at a specific position, and the flatness of the assembled pins 201, 211 can also be improved, such that SMT operation can be smoother and the waste of solder paste can be reduced. In addition, the influence of parasitic capacitance between the two electronic components 20, 21 can also be reduced by arranging the spacer 14.

In this embodiment, as illustrated in FIG. 3, the electronic components 20, 21 may be fixedly arranged in the positioning grooves 15, 16 through an adhesive 40. For example, before the electronic components 20, 21 are assembled to the housing 10, the adhesive 40 may be applied in the positioning grooves 15, 16, and then the electronic components 20, 21 are assembled to the positioning grooves 15, 16 to provide further positioning through the adhesive 40.

Next, referring to FIG. 2 and FIG. 3, in this embodiment, a side, towards the spacer 14, of the positioning part 12 includes a first inclined plane 121. A side, towards the spacer 14, of the other positioning part 13 includes a second inclined plane 131. The first inclined plane 121 and the second inclined plane 131 are inclined towards different directions. In this way, when the electronic components 20, 21 are placed into the housing 10, under the limit of the first inclined plane 121 and the second inclined plane 131, they may be arranged in a manner of extending towards the direction of the two outer sides. In other implementations, a plane perpendicular to the bottom of the body 11 rather than an inclined plane may also be adopted.

In addition, in order to ensure that the pins 201, 211 can be exactly and correspondingly arranged in the slots 117, 118 after the electronic components 20, 21 are placed into the positioning grooves 15, 16 along the first inclined plane 121 or the second inclined plane 131, the slots 117, 118 may be located between an extension line L1 of the first inclined plane 121 and an extension line L2 of the second inclined plane 131. Alternatively, as illustrated in FIG. 3 of this embodiment, the slot 117 is arranged close to the extension line L1 of the first inclined plane 121, and the slot 118 is arranged close to the extension line L2 of the second inclined plane 131.

Continuously referring to FIG. 3, a side, towards the positioning part 12, of the spacer 14 includes a third inclined plane 141. A side, towards the other positioning part 13, of the spacer 14 includes a fourth inclined plane 142. The third inclined plane 141 is parallel to the first inclined plane 121. The fourth inclined plane 142 is parallel to the second inclined plane 131. When the electronic component 20 is placed into the housing 10, under the limit of the first inclined plane 121 of the positioning part 12 and the third inclined plane 141 of the spacer 14, it can be accurately placed into the positioning groove 15. When the electronic component 21 is placed into the housing 10, under the limit of the second inclined plane 131 of the positioning part 13 and the fourth inclined plane 142 of the spacer 14, it can be accurately placed into the positioning groove 16.

Further, in order to ensure that the pins 201, 211 can be exactly and correspondingly arranged in the slots 117, 118 after the electronic components 20, 21 are placed into the positioning grooves 15, 16 under the limiting effect, the bottom of the slot 117 is located between the extension line L1 of the first inclined plane 121 and an extension line L3 of the third inclined plane 141, and the bottom of the slot 118 is located between the extension line L2 of the second inclined plane 131 and an extension line L4 of the fourth inclined plane 142. In actual operation, the above arrangement makes the electronic components 20, 21 have a space for rotation in the positioning grooves 15, 16, such that the electronic components 20, 21 can be more easily placed into the positioning grooves 15, 16 in the housing 10.

Moreover, since the width of the electronic components 20, 21 is at most the width of the positioning grooves 15, 16, the width of the slots 117, 118 may also be defined as a range between the extension lines, such that the slots 117, 118 can provide a further effect of limiting the electronic components 20, 21, without making a space for the electronic components 20, 21 to be shifted leftwards and rightwards too much.

Next, referring to FIG. 2, in order to provide a better limiting effect when the electronic components 20, 21 are placed into the accommodating space 111, the positioning parts 12, 13 are arranged in a manner of extending between the two sides of the body 11 the slots 117 and 118 are arranged at. That is to say, the positioning parts 12, 13 extend between the second side 114 and the fourth side 116. Further, the spacer 14 may also be arranged in a manner of extending between the two sides of the body 11 the slots 117, 118 are arranged at. That is to say, as illustrated in FIG. 2, the spacer 14 extends between the second side 114 and the fourth side 116.

In other implementations, the positioning parts 12, 13 and the spacer 14 may also be arranged at a middle section between the second side 114 and the fourth side 116. Alternatively, a plurality of sections of positioning parts 12, 13 and spacer 14 are arranged at a specific interval between the second side 114 and the fourth side 116, as long as the effect of limiting the electronic components 20, 21 can be provided.

Referring to FIG. 1 and FIG. 3, when the electronic components 20, 21 are arranged in the housing 10 and the pins 201, 211 are arranged in the slots 117, 118, the depth of the slots 117, 118 is smaller than the diameter of the pins 201, 211. As illustrated in FIG. 3, a distance between the bottom of the slots 117, 118 and the opening 112 is a depth D. When the diameter of the pins 201, 211 is larger than the depth D of the slots 117, 118, the pins 201, 211 slightly protrude out of the opening 112 when arranged in the slots 117, 118. For example, the relationship between the depth D of the slots 117, 118 and the diameter of the pins 201, 211 can make the length of the pins 201, 211 beyond the opening 112 be between 0.05 mm and 0.1 mm, but the present disclosure is not limited thereto. However, if the pins 201, 211 are not circular but plate-shaped, the depth D is enabled to be slightly smaller than the thickness of the pins. In this way, when the dual-port electronic assembly 100 is assembled on the circuit board (not shown), the pins 201, 211 will effectively and flatly contact the circuit board, and under the acting force of the bottom of the slots 117, 118, they can be in close contact with the circuit board. When SMT operation is carried out, there is no need to use a large amount of the solder paste to ensure that the pins 201, 211 are connected to the circuit on the circuit board.

In addition, in this embodiment, the housing 10 further includes a cover body 30 covering the opening 112. For the purpose of attractive appearance or dust prevention or the like, the cover body 30 may also be used to cover the opening 112, and the pins 201, 211 may be enabled to be exposed outside the housing 10. The cover body 30 may be fixed to the body 11 through clamping, fastening or bonding. It should be noted that, if the cover body 30 is provided, the pins 201, 211 need to slightly protrude out of the cover body 30 after the cover body 30 is closed. Therefore, the pins 201, 211 can be ensured to effectively and flatly contact the circuit board.

As illustrated in FIG. 3, a spacing W is formed between the two electronic components 20, 21 after placed, and the formed spacing W can reduce the influence of the parasitic capacitance between the two electronic components 20, 21. In fact, during design, a better spacing between the two electronic components may be calculated according to different types and sizes of the electronic components, and then the arrangement positions of the positioning parts 12, 13 and the spacer 14 in the housing 10, the relative position relationship, or the inclination angle formed by the positioning grooves 15, 16 may be designed, such that there is a required spacing between the two electronic components.

Although the present disclosure is described with reference to the above embodiments, the embodiments are not intended to limit the present disclosure. A person of ordinary skill in the art may make variations and modifications without departing from the spirit and scope of the present disclosure. Therefore, the protection scope of the present disclosure should be subject to the appended claims.

What is claimed is:

1. A dual-port electronic assembly, comprising:
a housing, comprising:
a body, comprising an accommodating space, an opening and two slots, wherein the opening is located at a side of the accommodating space, and the two slots are respectively located at two opposite sides of the opening;
two positioning parts, arranged in the accommodating space, and the two positioning parts respectively located on two sides different from the two sides the slots are arranged at; and
a spacer, arranged in the accommodating space and located between the two positioning parts and a positioning groove formed between each of the positioning parts and the spacer; and
two electronic components, each of the electronic components comprising a main body and two pins, wherein the main body of each of the electronic components is located in the positioning groove, and the two pins of each of the electronic components are respectively arranged in the two slots.

2. The dual-port electronic assembly according to claim 1, wherein each of the electronic components is a thermistor.

3. The dual-port electronic assembly according to claim 1, wherein each of the electronic components is fixedly arranged in the positioning groove through an adhesive.

4. The dual-port electronic assembly according to claim 1, wherein a side, towards the spacer, of one of the two positioning parts comprises a first inclined plane, a side, towards the spacer, of another positioning part comprises a second inclined plane, and the first inclined plane and the second inclined plane are inclined towards different directions.

5. The dual-port electronic assembly according to claim 4, wherein the slots are located between an extension line of the first inclined plane and an extension line of the second inclined plane.

6. The dual-port electronic assembly according to claim 4, wherein a side, towards one of the two positioning parts, of the spacer comprises a third inclined plane, a side, towards the other positioning part, of the spacer comprises a fourth inclined plane, the third inclined plane is parallel to the first inclined plane, and the fourth inclined plane is parallel to the second inclined plane.

7. The dual-port electronic assembly according to claim 1, wherein the two positioning parts are arranged in a manner of extending between the two sides of the body the slots are arranged at.

8. The dual-port electronic assembly according to claim 1, wherein the spacer is arranged in a manner of extending between the two sides of the body the slots are arranged at.

9. The dual-port electronic assembly according to claim 1, wherein the depth of each of the slots is smaller than the diameter of each of the pins such that each of the pins slightly protrudes out of the opening when arranged in each of the slots.

10. The dual-port electronic assembly according to claim 1, wherein the housing further comprises a cover body covering the opening.
